(19) United States
(12) Patent Application Publication
(10) Pub. No.: US 2022/0250081 A1
(43) Pub. Date: Aug. 11, 2022

(54) ROLLER MILL AND METHOD FOR OPERATING A ROLLER MILL

(71) Applicant: thyssenkrupp Industrial Solutions AG, Essen (DE)

(72) Inventor: Frank SCHROERS, Ahlen (DE)

(73) Assignee: thyssenkrupp Industrial Solutions AG, Essen (DE)

(21) Appl. No.: 17/622,347

(22) PCT Filed: Jun. 23, 2020
(86) PCT No.: PCT/EP2020/067540

§ 371 Date: Dec. 23, 2021

(30) Foreign Application Priority Data
Jun. 28, 2019 (DE) 10 2019 209 514.3

(51) Int. Cl. B02C 4/40; B02C 4/02; B02C 25/00; B02C 4/30

(52) U.S. Cl. CPC B02C 4/40; B02C 4/02; B02C 2210/02; B02C 4/305; B02C 25/00

(57) ABSTRACT

A roller mill for comminuting material may include first and second grinding rollers disposed opposite one another and drivable in opposite directions and a milling gap between the grinding rollers. An end region of at least the first grinding roller comprises a peripheral element that extends across the milling gap and at least partially covers an end side of the second grinding roller. A scraping element for at least partially removing material is disposed on the end region of the first grinding roller. A measuring device can determine a layer thickness of ground material on at least one of the grinding rollers and/or determine stress in the peripheral element. A control device connected to the measuring device is configured, based on the determined layer thickness and/or stress, to decrease or increase an amount of space between the scraping element and one of the grinding rollers.

The invention relates to a roller mill having peripheral elements for comminuting granular material, and to a method for operating a roller mill.

Roller mills are typically used for comminuting ground material such as, for example, limestone, clinker, or similar rocks. In the comminution of ground material in a roller mill it arises that ground material exits the milling gap laterally without having completely or at all passed the milling gap. This leads to a reduction of the throughput rate of the machine and to an increase in the grinding revolutions, which is associated with an enormous input of energy.

In order for the lateral outflow of ground material from a milling gap configured between the grinding rollers of a roller mill to be influenced in a controlled manner it is known for peripheral elements to be disposed on one of the grinding rollers. Such a roller mill having peripheral elements is known from DE 20 2014 006 837 U1, for example. An increased specific grinding pressure acts on the peripheral elements, said increased specific grinding pressure leading to high stress on the peripheral elements and thus often leading to wear or breakage on the peripheral elements.

Proceeding therefrom, it is an object of the present invention to provide a roller mill having peripheral elements, wherein the peripheral elements are subjected to less stress and wear.

This object is achieved according to the invention by a device having the features of independent device claim 1, and by a method having the features of independent method claim 12. Advantageous refinements are derived from the dependent claims.

A roller mill for comminuting granular material according to a first aspect comprises a first grinding roller and a second grinding roller which are disposed so as to be opposite and drivable in a counter-rotating manner, wherein a milling gap is configured between the grinding rollers. At least one of the grinding rollers on an end region of a grinding roller end comprises a peripheral element which is configured in such a manner that said peripheral element extends across the milling gap and at least partially covers the opposite grinding roller on the end side.

A scraping element for removing material is disposed on the end region of the grinding roller end that is provided with a peripheral element. The scraping element serves in particular for at least partially removing material that has accumulated on the end region of the grinding roller. The material is scraped by the scraping element in the operation of the roller mill, wherein the grinding rollers rotate in a counter-rotating manner. The scraping element is preferably disposed on the end region of the grinding roller in such a manner that said scraping element does not contact the grinding roller. The end region of the grinding roller comprises, for example, the end side of the grinding roller, the grinding roller surface adjacent thereto, as well as a region which surrounds the grinding roller surface and in which material accumulates. For example, such a region comprises a height of more than or equal to 2 mm to 10 mm, in particular more than or equal to 4 mm to 8 mm, preferably 5 mm.

The peripheral element comprises in particular an encircling circular ring, preferably a circular disk. The peripheral element is in particular attached to the end side of the respective grinding roller, for example screw-fitted or welded thereto.

One end-side gap is in each case preferably configured between the peripheral elements and the end side of the respective opposite grinding roller. An end-side gap prevents a collision between the peripheral element and the end region of the respective opposite grinding roller in the event of the grinding rollers running off track, wherein the opposite grinding rollers are disposed so as not to be mutually parallel.

The grinding rollers comprise in particular a roller main body, wherein the peripheral element is releasably connected to the roller main body of the respective grinding roller. The grinding roller preferably comprises a drive shaft for driving the grinding roller, the roller main body being disposed on said drive shaft. A releasable disposal of the peripheral elements on the roller main body offers the advantage of a rapid and simple replacement of the peripheral elements in the event of wear. The peripheral elements are adhesively bonded, soldered/brazed, welded, or screw-fitted to the roller main body, for example, and preferably comprise a wear-protection feature. The wear-protection feature is in particular disposed on the internal face of the peripheral element that points in the direction of the milling gap. Such a wear-protection feature comprises a wear-resistant coating, for example, such as a surface-welding, wear-protection elements, or wear-protection coatings. The peripheral elements are preferably configured from steel.

In the operation of the roller mill, a material layer is usually formed on the surface of the grinding rollers, said material layer having the effect of an autogenous wear-protection feature of the roller surface. According to one insight of the inventor, said wear-protection layer is thicker on those end regions of the roller ends that are provided with peripheral elements than, on the remaining regions of the grinding rollers. This leads to an increased grinding pressure on account of which the peripheral elements are more heavily stressed and wear or fail more often. The material accumulation on the grinding roller ends on the peripheral elements is reliably prevented by means of the scraping elements. The risk of increased wear and of a failure of the peripheral elements is minimized on account thereof.

The roller mill according to the invention has a measuring device for determining the layer thickness of ground material on at least one of the grinding rollers and/or for determining the stress of the peripheral element. The roller mill furthermore has a control device which is connected to the measuring device and, as a function of the determined layer thickness and or stress, is configured for decreasing or increasing the spacing of the scraping element from the grinding roller. The control device comprises, for example, a computer and is preferably connected to the measuring device in such a manner that the data collected by means of the measuring device, such as the stress and/or the layer height of the ground material on the grinding roller, is transmitted to the control device. The stress comprises the forces acting on the peripheral element or the relative elongation of the peripheral element, for example.

The scraping element is preferably disposed so as to be spaced apart from the peripheral element and/or the end region of the grinding roller. The spacing between the scraping element and the peripheral element and/or the end region of the grinding roller is preferably more than or equal to 2 mm to 10 mm, in particular 4 mm to 8 mm, preferably 5 mm. A spacing between the scraping element and the peripheral element and/or the end region of the grinding roller prevents contact between the scraping element and the grinding roller and thus minimizes the wear on the scraping element.

The scraping element is disposed in such a manner that the spacing between the scraping element and the peripheral element and/or between the scraping element and the end region of the grinding roller is capable of being set. In particular, the thickness of the material layer on the end regions of the grinding rollers should not exceed a specific value of, for example, 2 mm to 10 mm, in particular 4 mm to 8 mm, preferably 5 mm. A spacing that is capable of being set ensures that the spacing between the scraping element and the peripheral element and/or the end region of the grinding roller is kept constant in the event of wear on the scraping element. Additionally, the service life of the scraping element is extended, and a replacement in the event of wear is not required.

Each of the grinding rollers on an end region of a roller end preferably has a peripheral element which is configured in such a manner that said peripheral element extends across the milling gap and at least partially covers the opposite grinding roller on the end side. In particular, the peripheral elements are disposed so as to be diagonally opposite in terms of the end regions of the grinding rollers. The scraping element extends in particular along a peripheral element. In particular, the scraping element in the radial direction of the grinding roller extends so as to be parallel or oblique to the peripheral element, for example. The spacing between the peripheral element and the scraping element is preferably consistent across the length of the scraping element.

According to a first embodiment, the scraping element is attached to a holder, wherein the holder is configured so as to be movable in the direction of the grinding roller. For example, the holder extends substantially in the radial direction of the grinding roller. The holder preferably comprises the spindle or a telescopic bar, wherein said spindle or telescopic bar are in each case able to be driven by means of an electric motor, for example, or manually by means of a handwheel, such that the holder is moved in the direction of the grinding roller or away from the grinding roller. The holder is preferably movable in a linear manner. The scraping element is preferably attached to the holder in a releasable manner, for example by means of screws.

According to a further embodiment, the roller mill has a first measuring device for determining the layer height of ground material on the grinding roller, and a second measuring device for determining the stress of the peripheral element. The first measuring device is preferably attached to a machine frame which is stationary relative to the rotating grinding rollers. The first measuring device is in particular disposed in such a manner that said first measuring device determines the layer height of the ground material on the grinding roller at the upper reversal point of said ground material during the rotation of the grinding roller. The scraping elements in the rotating direction of the grinding roller are preferably disposed at the position ahead of the upper reversal point. The second measuring device is attached to the peripheral element, for example. The roller mill preferably has two each of the first and of the second measuring device, wherein one second measuring device is attached to each peripheral element, and one first measuring device is attached to each end region of a grinding roller provided with a peripheral element. The first and the second measuring device are in each case preferably connected to the control device in order for the determined measured data to be transmitted. The plurality of measuring devices serve for reliably monitoring each peripheral element of the roller mill.

According to a further embodiment, the first measuring device is an optical measuring device, in particular a laser measuring device, an infrared measuring device or an electromagnetic measuring device such as a radio measuring device (microwaves in the range of 1-300 GHz). The measuring method hereunder is to be understood to be the optical measuring method, the laser measuring method as well as the radar measuring method. In the case of the radar measurement, the measuring device is preferably attached above the grinding roller so as to be at a previously known spacing from the surface of the grinding roller. The layer height is preferably determined by means of an optical measuring method or the radar measurement in a lateral peripheral region of the grinding roller. It is likewise conceivable that a surface region which extends across the entire width and length of the grinding roller, or only across part of the grinding roller, for example the end region, is detected in particular by means of radar measurement. In such a radar measurement, the surface of the ground material on the grinding roller is detected in a planar manner, and the highest value of the layer height in this area is determined, for example.

For example, a plurality of measuring devices that are attached above the surface of the grinding roller, for example so as to be uniformly spaced apart across the circumference, so as to preferably detect a surface region of the grinding roller and to determine, preferably in a planar manner, the layer height in this region. For example, the height of the ground material is determined at a multiplicity of individual, mutually spaced apart, measuring points, a two-dimensional image of the ground material surface being determined therefrom by means of interpolation, for example.

The measuring methods for determining the layer height represent a simple and reliable possibility for determining the layer height during the operation of the roller mill.

According to a further embodiment, the second measuring device comprises a strain gauge. The second measuring device comprises in particular a plurality of strain gauges, preferably 2, 4, 6, 8 or 10 strain gauges. The strain gauges are attached to the peripheral element so as to be uniformly spaced apart on the circumference, for example. A strain gauge is in particular attached to a screw by means of which the peripheral element, or a segment of the peripheral element, is connected to the main body of the roller. The strain gauge determines the relative elongation or compression of the region to which said strain gauge is attached, the stresses arising on said region, in particular the forces acting on the peripheral elements and/or the screws, being determined therefrom.

According to a further embodiment, the control device is configured in such a manner that said control device decreases the spacing between the scraping element and the grinding roller if the layer height exceeds a previously determined threshold value. The threshold value is, for example, 2 mm to 10 mm, particularly 4 mm to 8 mm, preferably 5 mm. The spacing is preferably increased if the layer height undershoots the previously determined threshold value. When the layer height exceeds the previous determined threshold value, a conclusion can be drawn with respect to wear on the scraping element. The threshold value is preferably stored in the control device. The worn region of the scraping element is compensated for by decreasing the spacing. Excessive wear on the scraping element is likewise counteracted when the spacing is increased. The spacing is in particular to be understood to be the spacing between the scraping element and the surface of the main body of the roller, in particular the grinding face of the grinding roller.

According to a further embodiment, the control device is configured in such a manner that said control device decreases the spacing between the scraping element and the grinding roller if the stress, in particular the elongation of the peripheral element, exceeds a previously determined threshold value. The spacing by means of the control device is preferably increased when the stress, in particular the relative elongation of the peripheral element, undershoots the previously determined threshold value.

According to a further embodiment, the measuring device in the rotating direction of the grinding roller is disposed between the scraper and the milling gap. As a result, the function of the scraper is monitored, wherein the layer thickness is determined at a location where no further material is pressed onto the roller.

The scraping element is preferably disposed in such a manner that said scraping element removes material that in the operation of the roller mill has accumulated on the peripheral element and/or on the end region of the grinding roller. In particular, the scraping element is disposed so as to be stationary or movable relative to the rotatable grinding rollers such that the grinding rollers rotate relative to the scraping element.

The scraping element is preferably disposed in such a manner that said scraping element in the operation of the roller mill removes material that has accumulated on the peripheral element and/or on the end region of the grinding roller. In particular, the scraping element is disposed so as to be stationary or movable relative to the rotatable grinding rollers so that the grinding rollers rotate relative to the scraping element.

According to a further embodiment, the roller mill comprises a stationary machine frame, and the scraping element is attached to the machine frame. The machine frame comprises, for example, a plurality of frame elements which are connected to bearing jewels of the grinding rollers such that the grinding force acting on the grinding rollers is transmitted to the machine frame. A machine frame of a roller mill comprises in particular a frame element which extends substantially in the axial direction of the grinding rollers and to which the scraping element is preferably attached. The scraping element extends from the machine frame in the direction of the grinding roller, in particular in the end region of the grinding roller.

The roller mill according to a further embodiment comprises at least two scraping elements which are disposed on end regions of dissimilar roller ends of the grinding roller. The scraping elements are preferably disposed on opposite end regions of a grinding roller. Each scraping element is preferably attached to in each case one holder which is attached so as to be movable in the direction of the grinding roller.

According to a further embodiment, the scraping element comprises a scraping plate which is configured from a wear-resistant material such as, for example, tungsten carbide. The scraping plate is disposed on that end of the scraping element that faces the grinding roller and in the operation of the roller mill is in contact with the material to be scraped. The scraping plate is therefore subjected to high wear, wherein a wear-resistant material extends the service life of the scraping plate.

The scraping element according to a further embodiment comprises an arm to which the scraping plate is releasably fastened. For example, the scraping plate is clamped or screw-fitted to the arm. The scraping plate in the direction of the grinding roller preferably projects beyond the arm. A releasable fastening of the scraping plate of the scraping element enables the scraping plate to be readily replaced, said scraping plate representing the most wear-intensive region of the scraping element. Replacement of the entire scraping element in the event of wear is thus not required.

The invention also comprises a method for operating a roller mill for comminuting granular material having a first grinding roller and the second grinding roller which are disposed so as to be opposite and drivable in a counter-rotating manner, wherein a milling gap is configured between the grinding rollers and wherein at least one of the grinding rollers on an end region of a grinding roller comprises a peripheral element which is configured in such a manner that said peripheral element extends across the milling gap and at least partially covers the opposite grinding roller on the end side, wherein a scraping element for at least partially removing material is disposed on the end region of the grinding roller that is provided with a peripheral element, wherein the method comprises at least the step of:

determining a layer height of ground material on at least one of the grinding rollers; and/or

determining a stress of the peripheral element; and

setting the spacing between the scraping element and the grinding roller as a function of the determined layer height and/or stress.

The advantages described in the context of the grinding roller apply in an analogous manner to the method for operating a roller mill for comminuting granular material.

The material is preferably removed on two end regions of the grinding roller that are in each case provided with one peripheral element. According to a further embodiment, the spacing is decreased if the determined layer height exceeds a previously determined threshold value.

According to a further embodiment, the spacing is decreased if the stress exceeds a previously determined threshold value.

### DESCRIPTION OF THE DRAWINGS

The invention is explained in more detail hereunder by means of a plurality of exemplary embodiments with reference to the appended figures in which:

FIG. 1 shows a schematic illustration of a fragment of a roller mill in a plan view, according to an exemplary embodiment;

FIG. 2 shows a schematic illustration of a fragment of a roller mill in a plan view, according to a further exemplary embodiment;

FIG. 3 shows a schematic illustration of a fragment of a grinding roller having scraping elements in a perspective view, according to an exemplary embodiment;

FIG. 4 shows a schematic illustration of a scraping element in a perspective view, according to an exemplary embodiment; and

FIG. 5 shows a schematic illustration of the scraping element in FIG. 4, in a perspective rear view.

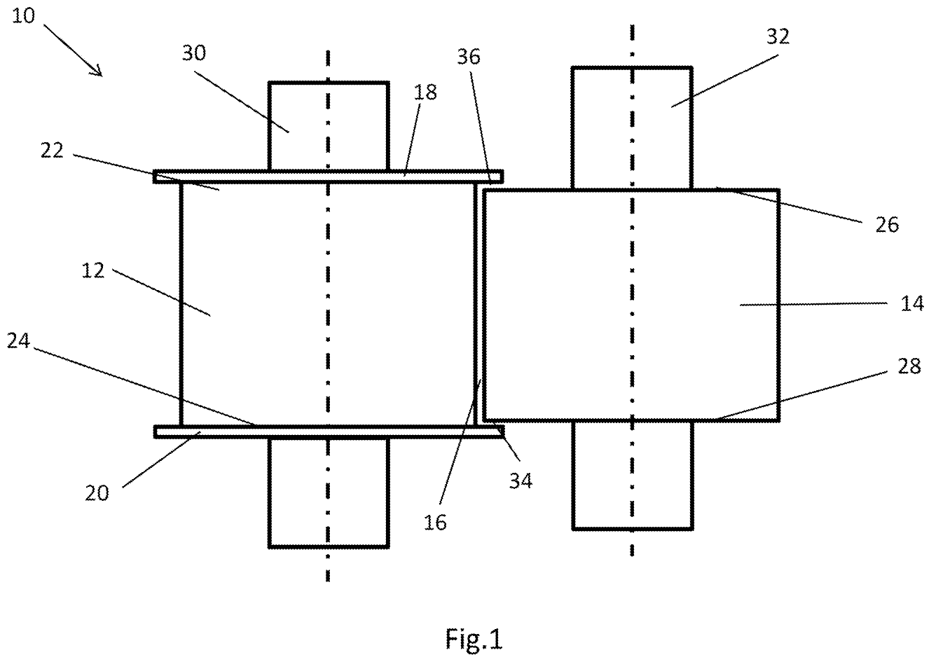

FIG. 1 shows a roller mill 10 having a first grinding roller 12 and a second grinding roller 14 which comprise in each case a substantially cylindrical roller main body. The grinding rollers 12, 14 are disposed so as to be opposite and drivable in a counter-rotating manner. A milling gap 16 which extends in the axial direction is configured between the grinding rollers 12, 14. The grinding rollers 12, 14 are disposed so as to be almost mutually parallel such that the milling gap 16 extending between the grinding rollers 12, 14 comprises an almost consistent width. Each of the grinding rollers 12, 14 furthermore comprises a drive shaft 30, 32 which extends along the central axis extends through the respective grinding roller 12, 14 and drives the grinding rollers so as to rotate about the central axes of the latter. The first and the second grinding roller 12, 14 comprise identical diameters, wherein the first grinding roller 12 can be longer than the second grinding roller 14.

The grinding rollers 12, 14 comprise in each case a first end region 24, 28 and a second end region 22, 26 which are disposed on opposite ends of the grinding roller. The first end region 24 of the first grinding roller 12 is disposed so as to be opposite the first end region 28 of the second grinding roller 14, wherein the second end region 22 of the first grinding roller 12 is disposed so as to be opposite the second end region 26 of the second grinding roller 14.

By way of example, the first grinding roller 12 comprises two peripheral elements 18, 20 which are in each case attached to an end region of the grinding roller 12. The first peripheral element 18 is attached to the first peripheral region 22 of the first grinding roller 12 and in the radial direction extends beyond the milling gap 16 such that said first peripheral element 18 partially covers the end side of the second grinding roller 14 on the first end region 26. The second peripheral element 20 is attached to the second end region 24 of the first grinding roller 12 and in the radial direction extends beyond the milling gap 16 such that said second peripheral element 20 partially covers the end side of the second grinding roller 14 the second end region 28. One end-side gap 34, 36 is in each case configured between the peripheral elements 18 and the respective end side of the second grinding roller 14.

The peripheral elements 18, 20 preferably comprise in each case an encircling circular ring which can also be composed of segments, for example, and is attached to the respective grinding roller 12, 14 (not illustrated). For example, the peripheral elements 18, 20 are attached to the end side or to the external circumference of the grinding roller, in particular the respective roller main body.

For example, an encircling groove in which one peripheral element 18, 20 is in each case disposed is disposed on the external circumference of the respective grinding roller 12, 14. The peripheral elements 18, 20 are configured from a wear-resistant material such as, for example, steel, and comprise a wear-resistant coating or a plurality of, for example, plate-like wear-protection elements in particular on the internal side that points toward the milling gap 16. The peripheral elements 18, 20 comprise a thickness of, for example, 10 mm to 100 mm, and cover the opposite grinding rollers 12, 14 by approximately 2 to 20%, in particular 4 to 10%, preferably 3 to 6%, of the roller diameter.

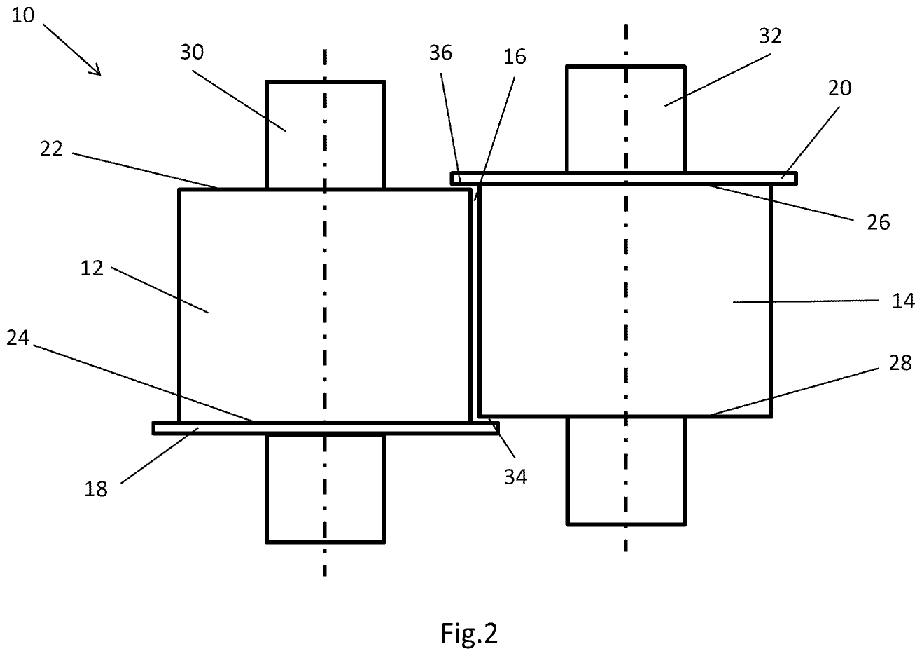

FIG. 2 shows a further embodiment of a grinding roller having peripheral elements 18, 20, wherein the grinding roller corresponds substantially to the grinding roller illustrated in FIG. 1 but differs in that each of the grinding rollers 12, 14 in the exemplary embodiment in FIG. 2 comprises in each case one peripheral element 18, 20. The first and the second grinding roller 12, 14 comprise identical diameters and identical lengths and are configured so as to be of substantially identical construction.

The peripheral elements 18, 20 in terms of the end regions 22 to 28 of the grinding rollers 12, 14 are disposed so as to be diagonally opposite. The first grinding roller 12 on the first end region 24 thereof comprises a peripheral element 18 which in the radial direction extends across the milling gap 16 and partially covers the end side of the second grinding roller 14 on the first end region 28. The second grinding roller 14 on the second end region 26 thereof comprises a peripheral element 20 which in the radial direction extends across the milling gap 16 and partially covers the end side of the first grinding roller 12 on the second peripheral region 22 thereof. The second peripheral element 20 in terms of the first peripheral element 18 is disposed on the diagonally opposite end region 26 of the second grinding roller 14. The grinding rollers 12, 14 are disposed so as to be offset in the axial direction such that a first end-side gap 34 is configured between the first peripheral element 18 and the end side of the second grinding roller 14, and a second end-side gap 36 is configured between the second peripheral element 20 and the end side of the first grinding roller 12. The first and the second end-side gap 34, 36 extend in each case in the radial direction.

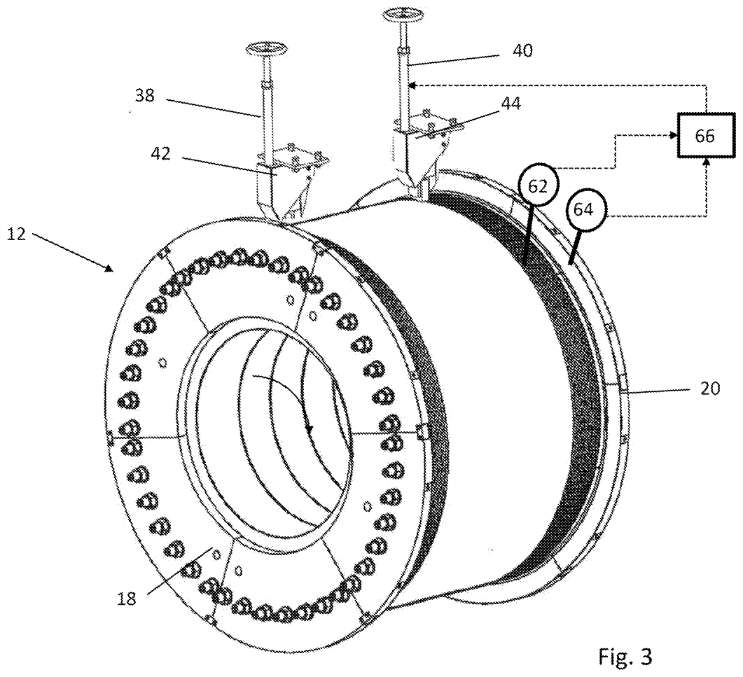

FIG. 3 shows a fragment of a first grinding roller 12 of the roller mill 10 according to FIG. 1. By way of example, the peripheral elements 18, 20 comprise a plurality of part-circular segments which are each screwed onto the end face of a respective end region of the grinding roller 12. Each segment is fastened to the end side of the grinding roller 12 with a plurality of screws or bolts.

FIG. 3 also shows two scraping elements 42, 44 which in each case are attached to a holder 38, 40 and in each case extend in the direction of a respective end region of the grinding roller 12. The holders 38, 40 are preferably in each case fastened to a machine frame (not illustrated), wherein in particular the grinding rollers 12, 14 are situated on the machine frame. The scraping elements 42, 44 are disposed so as to be spaced apart from the grinding roller 12 and the peripheral element 18, 20 of the grinding roller 12 such that the scrapers do not touch the grinding roller 12 and the peripheral elements 18, 20. The first scraping element 42 is attached in such a manner that it lies opposite the first end region 22 of the grinding roller 12, wherein the first scraping element 42 in the radial direction of the grinding roller 12 extends along the first peripheral element 18 and is aligned so as to be substantially parallel to the latter. However, other alignments are also possible.

The second scraping element 44 in a corresponding manner is disposed on the second end region 24 and the second peripheral element 20 of the grinding roller 12. The scraping elements 42, 44 extend in each case along the face of the peripheral elements 18, 20 that points inward in the axial direction of the grinding roller 12. The scraping elements 42, 44 are configured so as to be mutually identical, for example.

The holders 38, 40 are preferably configured in such a manner that said holders 38, 40 are movable in and/or counter to the direction of the grinding roller 12 such that, in a movement of the holders 38, 40 in or counter to the direction of the grinding roller, the spacing between the grinding roller, in particular the surface of the grinding roller 12, 14, and the scraping element 42, 44 is decreased or increased. The holders 38, 40 are preferably able to be moved in a linear manner in the direction of the grinding roller 12, 14, or away from the grinding roller 12, 14. The holders 38, 40 are, for example, in each case a telescopic bar or a spindle which are preferably able to be driven by means of an electric motor, not illustrated, or manually by means of a handwheel.

FIG. 3 furthermore shows a first measuring device 62 for determining the layer thickness of the ground material adhering to the surface of the grinding roller. The first measuring device 62 is an optical measuring device, for example, wherein the layer thickness is determined by means of a laser, for example. The first measuring device 62 is preferably disposed in such a manner that the layer thickness of the ground material is determined on an end region of the grinding roller 12, 14, in particular close to one of the peripheral elements 18, 20 or on one of the latter. The measuring device 62 in the rotating direction of the grinding roller 12 is preferably attached behind the scraping element 42, 44 such that the layer thickness is determined circumferentially between the scraping element 42, 44 and the milling gap 16 during the operation of the roller mill 10. The rotating direction of the grinding roller 12 is illustrated by an arrow in FIG. 3. The first measuring device 62 is attached to the previously described machine frame, for example, and disposed so as to be stationary relative to the rotatable grinding rollers 12, 14.

The roller mill 10 furthermore has a second measuring device 64 which is attached to a peripheral element 18, 20 and is configured in such a manner that said second measuring device 64 determines the stress acting on the respective peripheral element 18, 20. Stress is to be understood as a force acting on the peripheral element 18, 20 and/or the stresses arising in the respective peripheral element 18, 20, for example. The second measuring device 64 is, for example, one or a plurality of strain gauges. The strain gauge is attached to the peripheral element 18, 20, for example, so as to determine the arising stresses, in particular the forces acting on the peripheral element. It is likewise conceivable for a plurality of strain gauges to be attached to different positions on the peripheral element 18, 20. For example, one or a plurality of screws for fastening the peripheral element 18, 20 to the main body of the grinding roller 12, 14 are in each case provided with one strain gauge. The second measuring device 64 in the rotating direction of the grinding roller 12, 14 is preferably disposed behind the scraping element 42, 44 and ahead of the milling gap 16.

The roller mill 10 furthermore comprises a control device 66 for setting the spacing between the scraping element 42, 44 and the surface of the grinding roller 12, 14. The control device 66 is connected to the first and/or the second measuring device 62, 64 in such a manner that the data determined by means of the respective measuring device 62, 64 is transmitted to the control device 66. The control device 66 is furthermore connected to the holder 38, 40, preferably to both holders 38, 40, of the scraping elements 42, 44. The control device 66 is in particular connected to an electric motor which moves the holders 38, 40 of the scraping elements 42, 44, preferably in the direction of the grinding roller 12, 14 or away from the grinding roller 12, 14. The control device 66 is connected to the holders 38, 40 and/or the electric motor in such a manner that said control device 66 by means of a control signal for movement can move the holders in the direction of the grinding roller 12, 14 or away from the grinding roller 12, 14.

FIG. 3 only shows the disposal of the scraping elements 42, 44 on a roller mill according to FIG. 1. A roller mill 10 illustrated in FIG. 2 by way of example likewise comprises two scraping elements 42, 44. Each grinding roller 12, 14 of the roller mill 10 illustrated in FIG. 2 comprises in each case one scraping element 42, 44 which is attached, for example, to a roller frame and, in a manner corresponding to the exemplary embodiment in FIG. 3, extends in the direction of a respective end region of the grinding roller 12, 14 that comprises a peripheral element 18, 20. It is likewise conceivable that one first measuring device 62 is attached to each end region of the grinding roller, and one second measuring device 64 is attached to each peripheral element 18, 20. All measuring devices 62, 64 are connected to a control device 66, for example.

For setting the spacing between the scraping element 42, 44 and the surface of the grinding roller 12, 14, the control device 66 compares the measured values transmitted by the first and/or the second measuring device 62, 64 with a corresponding, previously determined threshold value, for example. For example, the control device 66 compares the value of the layer height of the ground material on the grinding roller 12, 14 transmitted by means of the first measuring device 62 with a previously determined threshold value of the layer height, said threshold value being stored in the control device 66. The control device 66 is preferably configured and specified in such a manner that said control device 66, if the determined layer height exceeds the previously determined threshold value, decreases the spacing between the respective scraping element 42, 44 and the surface of the respective grinding roller 12, 14. To this end, the control device 66 transmits a control signal to the electric motor, for example, or to the holders 38, 40 such that the holders 38, 40 and the scraping elements 42, 44 fixedly attached thereto are moved in the direction of the grinding roller 12, 14, in particular in the direction of the surface of the grinding roller, and the spacing between the scraping elements 42, 44 and the surface of the grinding roller 12, 14 is decreased. The previously determined threshold value of the layer height is, for example, 2 mm to 10 mm, particularly 4 mm to 8 mm, preferably 5 mm. The control device 66 is preferably configured and specified in such a manner that said control device 66, if the determined layer height undershoots the previously determined threshold value, increases the spacing between the respective scraping element 42, 44 and the surface of the respective grinding roller 12, 14. An increased layer thickness of ground material on the grinding roller 12, 14 can be traced back to wear on the scraping element 42, 44, wherein decreasing the spacing of the scraping element 42, 44 from the surface of the grinding roller corresponds to a wear readjustment of the scraping element 42, 44 such that the wear on the scraping element 42, 44 is compensated for.

For example, the control device 66 compares the value of the stress, preferably of the elongation of the peripheral elements 18, 20, and/or the forces acting on the peripheral elements 18, 20 and/or the screws, transmitted by means of the second measuring device 64 with a previously determined threshold value of the respective stress, preferably of the elongation, that is stored in the control device 66. The control device 66 is preferably configured and specified in such a manner that said control device 66, if the determined stress, in particular the elongation, exceeds the previously determined threshold value, decreases the spacing between the respective scraping element 42, 44 and the surface of the respective grinding roller 12, 14. This preferably takes place as has been described above. The control device 66 is preferably configured and specified in such a manner that said control device 66, if the determined stress, in particular the elongation, undershoots the previously determined threshold value, decreases the spacing between the respective scraping element 42, 44 and the surface of the respective grinding roller 12, 14.

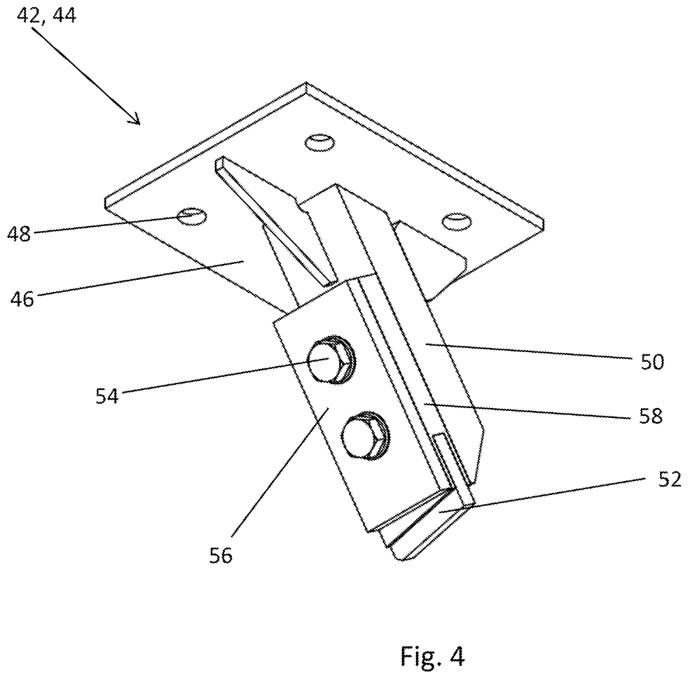

FIG. 4 shows an enlarged view of an exemplary scraping element 42, 44. The scraping element 42, 44 comprises a fastening plate 46 which in the assembled position of the scraping element 42, 44 is attached to the holder 38, 40. The fastening plate comprises a plurality of fastening bores 48 which serve for fastening the scraping element 42, 44 to the holder 38, 40, for example by means of screws.

An arm 50 is attached to the fastening plate 46, said arm 50 in relation to the fastening plate 46 extending at an angle of, for example, approximately 30 to 60°, in particular approximately 45°, in the direction of the grinding roller 12, 14 (not illustrated). A scraping plate 52 which is fastened to the arm 50 by means of two screws 54 and a clamping plate 56 is attached to the arm 50. The scraping plate in a manner parallel to the arm 50 extends beyond the end of the arm that faces away from the fastening plate 46 such that the scraping plate 52 on the arm 50 projects in the radial direction of the grinding roller 12, 14. The scraping plate 52 is clamped between the clamping plate 56 and the arm 50 such that said scraping plate is easy to replace in the event of wear. In an exemplary manner, the scraping plate 58 is disposed in a clamping receptacle 58 which is disposed between the clamping plate 56 and the arm 50 and is clamped by means of the clamping plate 56 and the screws 54.

The front edge of the scraping plate 52 in the exemplary embodiment in FIG. 4 extends at an angle in relation to the surface of the respective grinding roller 12, 14 such that the spacing between the scraping plate 52 and the surface of the grinding roller 12, 14 is less in the direction of the grinding roller end. The angle between the scraping plate 52 and the surface of the grinding roller 12, 14 is, for example, 45° to 135°. It is likewise conceivable that the front edge of the scraping plate 52 extends so as to be substantially parallel to the surface of the respective grinding roller 12, 14, in particular in the axial direction of the grinding roller. The lateral face of the scraping plate 52 as well as the lateral face of the arm 50 extend along the respective peripheral element 18, 20. In particular, a gap of 2 mm to 10 mm, preferably 4 mm to 8 mm, in particular 5 mm, is configured between the scraping element 42, 44 and the surface of the grinding roller 12, 14.

The fastening plate 46, the arm, the clamping receptacle 58, and the clamping plate 56 are configured from steel, for example. The scraping plate is configured from a highly wear-resistant material such as tungsten carbide, for example.

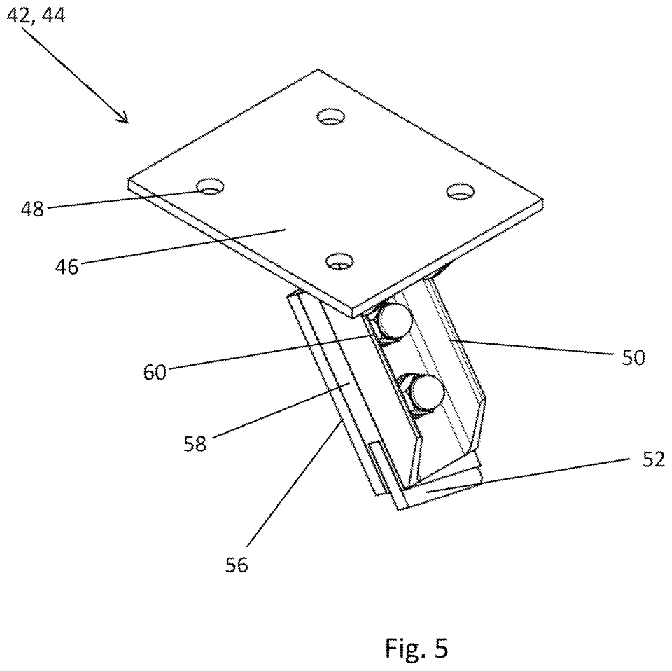

FIG. 5 shows a rear view of the scraping element 42, 44 in FIG. 4. The arm 50 in an exemplary manner comprises a substantially U-shaped profile, wherein the clamping plate 56 and the clamping receptacle 58 are attached to the arm 50 by means of screws 54 and nuts.

The peripheral elements 18, 20 in the operation of the roller mill 10 prevent material laterally exiting the milling gap 16. An autogenous wear-protection feature is constructed on the surface of the grinding rollers 12, 14 on account of the accumulation of material. The scraping elements 42, 44 during the rotation of the grinding roller 12, 14 scrape material that has accumulated on the end regions of the grinding roller 12, 14 and thus ensure that the autogenous wear-protection layer does not exceed a specific thickness even in the end regions of the grinding rollers 12, 14 to which the peripheral elements are attached such that the peripheral elements are reliably protected against high pressure on account of accumulated material.

### LIST OF REFERENCE SIGNS

10 Roller mill
12 First grinding roller
14 Second grinding roller
16 Milling gap
18 First peripheral element
20 Second peripheral element
22 First end region of the first grinding roller
24 Second end region of the first grinding roller
26 Second end region of the second grinding roller
28 First end region of the second grinding roller
30 Drive shaft of the first grinding roller
32 Drive shaft of the second grinding roller
34 First end-side gap
36 Second end-side gap
38 Holder
40 Holder
42 First scraping element
44 Second scraping element
46 Fastening plate
48 Fastening bores
50 Arm
52 Scraping plate
54 Screws
56 Clamping plate
58 Clamping receptacle
60 Nut
62 First measuring device
64 Second measuring device
66 Control device

1.-14. (canceled)

15. A roller mill for comminuting granular material, the roller mill comprising:
a first grinding roller and a second grinding roller that are disposed opposite one another and are drivable in a counter-rotating manner, wherein a milling gap is disposed between the first and second grinding rollers, wherein an end region of the first grinding roller includes a peripheral element that extends across the milling gap and at least partially covers an end side of the second grinding roller;
a scraping element for at least partially removing material, wherein the scraping element is disposed on the end region of the first grinding roller;
a measuring device for at least one of determining a layer thickness of ground material on at least one of the grinding rollers or for determining a stress of the peripheral element; and
a control device that is connected to the measuring device, wherein based on the layer thickness or the stress determined by the measuring device the control device is configured to decrease or increase an amount of space between the scraping element and one of the grinding rollers.

16. The roller mill of claim 15 wherein the scraping element is attached to a holder, wherein the holder is movable in a direction of the first grinding roller.

17. The roller mill of claim 15 wherein the measuring device is an optical measuring device that comprises a laser measuring device, an infrared measuring device, or an electromagnetic measuring device.

18. The roller mill of claim 15 wherein the measuring device is a first measuring device for determining the layer thickness of the ground material on the at least one of the grinding rollers, the roller mill comprising a second measuring device for determining the stress of the peripheral element.

19. The roller mill of claim 18 wherein the second measuring device comprises a strain gauge.

20. The roller mill of claim 15 wherein the control device is configured to decrease the amount of space if the layer thickness exceeds a predetermined threshold value.

21. The roller mill of claim 15 wherein the control device is configured to decrease the amount of space if the stress exceeds a predetermined threshold value.

22. The roller mill of claim 15 wherein with respect to a rotating direction of the first grinding roller, the measuring device is disposed between the scraping element and the milling gap.

23. The roller mill of claim 15 comprising a stationary machine frame to which the scraping element is attached.

24. The roller mill of claim 15 wherein the scraping element is a first scraping element, the roller mill comprising a second scraping element, wherein the end region of the first grinding roller on which the first scraping element is disposed is a first end region, wherein the second scraping element is disposed on a second end region of the first grinding roller.

25. The roller mill of claim 15 wherein the scraping element comprises a scraping plate that is configured of wear-resistant material.

26. The roller mill of claim 25 wherein the wear-resistant material is tungsten carbide.

27. A method for operating a roller mill for comminuting granular material, the roller mill including a first grinding roller and a second grinding roller that are disposed opposite one another and drivable in a counter-rotating manner, with a milling gap disposed between the first and second grinding rollers, wherein an end region of at least the first grinding roller comprises a peripheral element that extends across the milling gap and at least partially covers an end side of the second grinding roller, wherein a scraping element for at least partially removing material is disposed on the end region of the first grinding roller, the method comprising:
determining a layer thickness of ground material on at least one of the grinding rollers and/or determining a stress of the peripheral element; and
setting an amount of space between the scraping element and one of the grinding rollers based on the layer thickness or the stress that is determined.

28. The method of claim 27 comprising decreasing the amount of space when the layer thickness exceeds a predetermined threshold value.

29. The method of claim 27 comprising decreasing the amount of space when the stress exceeds a predetermined threshold value.
